(19) United States
(12) Patent Application Publication
(10) Pub. No.: US 2014/0192555 A1
(43) Pub. Date: Jul. 10, 2014

(54) PLANAR LIGHT APPARATUS

(71) Applicants: Dongguan Masstop Liquid Crystal Display Co., Ltd., (US); WINTEK CORPORATION, Taichung City (TW)

(72) Inventors: Zhi-Ting Ye, Miaoli County (TW); Wen-Chieh Wu, New Taipei City (TW); Ming-Chuan Lin, Taichung City (TW)

(73) Assignees: WINTEK CORPORAITON, Taichung City (TW); Dongguan Masstop Liquid Crystal Display Co., Ltd., Dongguan City (CN)

(21) Appl. No.: 13/864,210

(22) Filed: Apr. 16, 2013

(30) Foreign Application Priority Data
Jan. 7, 2013 (TW) 102100437

(51) Int. Cl. F21V 8/00

(52) U.S. Cl. CPC G02B 6/0031
USPC 362/609

(57) ABSTRACT

A planar light apparatus is disclosed and includes a reflection part, a secondary optic device, and a light-emitting device. The secondary optic device has a light incident surface, a light emitting surface, and a side surface, which is an elliptic surface, between the light incident surface and the light emitting surface. A reflecting surface of the reflection part and the light emitting surface face a void space formed between the secondary optic device and the reflection part. Light beams emitted by the light-emitting device into the secondary optic device through the light incident surface can be reflected by the side surface to emit out of the secondary optic device through the light emitting surface into the void space to be reflected by the reflecting surface. Thereby, the planar light apparatus without a conventional light-guiding plate still can offer a planar light source with certain uniformity and can be structured thinner.

### BACKGROUND OF THE INVENTION

1. Field of the Invention

The invention relates to a light apparatus, and especially relates to a planar light apparatus.

2. Description of the Prior Art

Illumination or back light devices have demands much for planar light sources. In addition to arranging light-emitting units in plane to form a planar light source, these devices usually use a physical light-guiding plate or multiple reflection structure with a light-emitting device which is disposed at a side thereof and emits light beams to be modulated by the light-guiding plate or multiple reflection structure to emit out of the devices forming a requested planar light source. However, the longer the path the light beam travels in the light-guiding plate is, the more serious the extent the light beam is absorbed by the light-guiding plate is, leading to a poor device lighting efficiency. Moreover, because of the limitation of the divergence angle of the light-emitting device, if the light beams emitted by the light-emitting device need to be converged efficiently, it is difficult to reduce the thickness of the multiple reflection structure, leading to difficulty in thinning the devices. In addition, there is a planar light apparatus using a secondary optic device whose reflecting surface is a parabolic surface. The parabolic surface is used to direct the light beams emitted by the light-emitting device disposed aside to be parallel light beams, so it is required to disposed a reflection sheet to slant to the parallel light beams so as to reflect and direct the parallel light beams to form a planar light source. If the thickness of the device is limited, it is difficult to reflect all the parallel light beams by the reflection sheet, so the device lighting efficiency is limited by the structural thickness of the device.

### SUMMARY OF THE INVENTION

An objective of the invention is to provide a planar light apparatus, which uses a secondary optic device having an elliptic reflecting surface. The planar light apparatus without a conventional light-guiding plate still can offer a planar light source with high lighting efficiency and certain uniformity and can be structured thinner, which solves the problem in the prior art of light intensity decay, constraints of structural thickness on a device lighting efficiency, difficulty in reducing a structural thickness of a device and so on.

The planar light apparatus of the invention includes a reflection part, a secondary optic device, and a light-emitting device. The reflection part has a reflecting surface. The secondary optic device has a light incident surface, a light emitting surface, and a side surface between the light incident surface and the light emitting surface. A void space is formed between the secondary optic device and the reflection part. The reflecting surface faces the void space. The secondary optic device is disposed such that the light emitting surface faces the void space. The side surface is an elliptic surface. A focus of the elliptic surface is located in the void space. A projection of the focus on the reflecting surface is substantially at the center of the reflecting surface; in other words, the focus is located substantially at a half of a length of the reflecting surface in the direction of an optical axis of the light-emitting device. The light-emitting device is disposed opposite to the light incident surface. Therein, light beams emitted by the light-emitting device into the secondary optic device through the light incident surface are capable of being reflected by the side surface to emit out of the secondary optic device through the light emitting surface into the void space to be reflected by the reflecting surface. Thereby, the secondary optic device can increase the efficiency of the light beams emitted by the light-emitting device being reflected by the reflection part, that is, to indirectly improve the whole device lighting efficiency. The planar light apparatus can offer a planar light source with certain uniformity without a light-guiding plate, which is conducive to structurally thinning to the apparatus. Furthermore, based on the geometric properties of ellipse, the light beams emitted by the light-emitting unit are modulated by the secondary optic device to travel toward the focus in principle, which is conducive to enhancement of the lighting efficiency of the planar light apparatus.

Compared with the prior art, the planar light apparatus needs no light-guiding plates, so that the light beams will not decay significantly. Compared with the conventional multiple reflection structure, the secondary optic device has advantages of small volume, good convergence and so on, which is conducive to structurally thinning to the planar light apparatus. In addition, the secondary optic device uses the elliptic reflecting surface, which can avoid the disadvantage of a convention parabolic surface leading to parallel light beams and can enhance the efficiency of the reflecting surface reflecting the light beams, that is, the device lighting efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of a planar light apparatus of a preferred embodiment according to the invention.

FIG. 2 is a sectional view of the planar light apparatus along the line X-X in FIG.

FIG. 3 is an enlarged view of a part of the planar light apparatus at the circle A in FIG. 2.

FIG. 4 is a perspective view of a secondary optic device according to another embodiment.

FIG. 5 is a sectional view of a planar light apparatus according to another embodiment.

FIG. 6 is a sectional view of a planar light apparatus according to another embodiment.

FIG. 7 is a sectional view of a planar light apparatus according to another embodiment.

### DETAILED DESCRIPTION

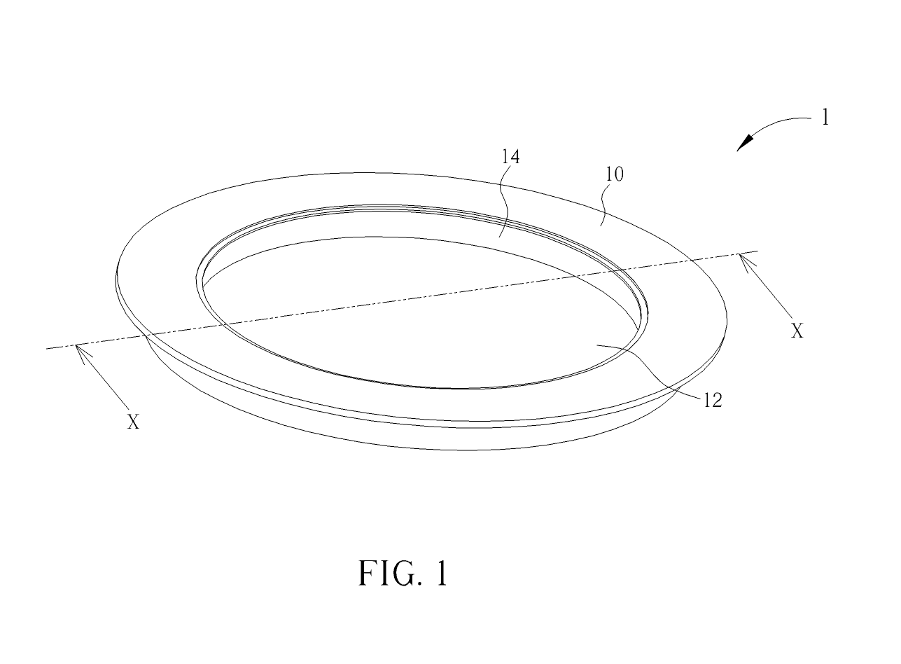

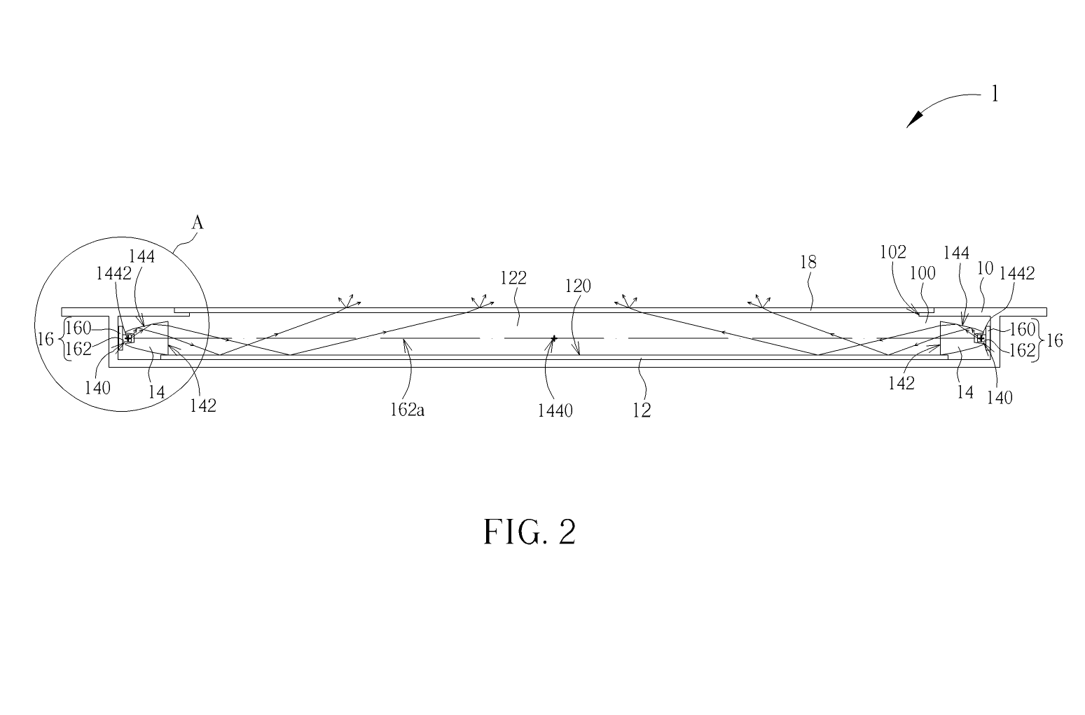

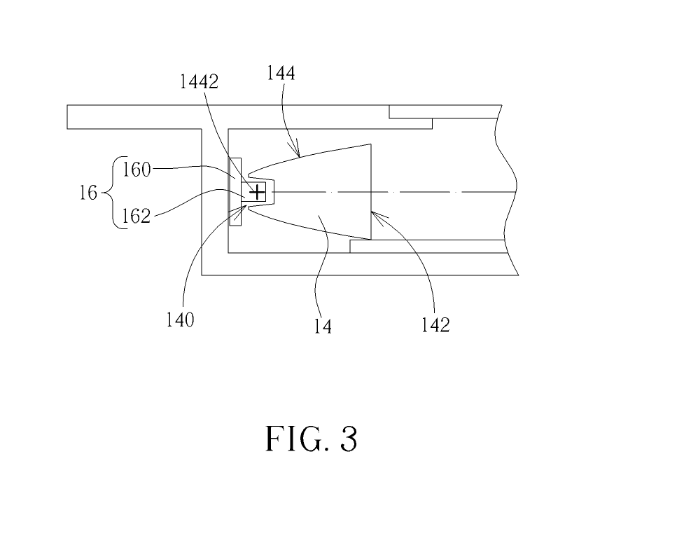

Please refer to FIGS. 1 through 3; therein, for a simplification of the lines in FIG. 2, hatched lines are not shown in FIG. 2, which is also applied to the following figures and will not be described in addition. In the embodiment, the planar light apparatus 1 includes a casing 10, a reflection part 12, a secondary optic device 14, a light-emitting device 16, and a diffusion plate 18 (not shown in FIG. 1 for a clear view inside the planar light apparatus 1). The casing 10 is disc-shaped and has an accommodating space 100 and a window 102. The reflection part 12 is disposed in the accommodating space 100 and has a reflecting surface 120 toward the window 102. A void space 122 is formed between the secondary optic device 14 and the reflection part 12. The reflecting surface 120 faces the void space 122. In the embodiment, the portion of the accommodating space 100 above the reflecting surface 120 is defined as the void space 122. The secondary optic device 14 is disposed in the accommodating space 100 has a light incident surface 140, a light emitting surface 142, and a side surface 144 between the light incident surface 140 and the light emitting surface 142. The light emitting surface 142 faces the void space 122. In the embodiment, the secondary optic device 14 is a circular part disposed around the reflection part 12. The light emitting surface 142 surrounds the void space 122. The light-emitting device 16 is disposed in the accommodating space 100 and has a circuit board 160 and a plurality of light-emitting units 162 disposed on the circuit board 160. The light-emitting units 162 are disposed opposite to the light incident surface 140 and around the secondary optic device 14. Light beams emitted by the light-emitting units 162 enter the secondary optic device 14 through the light incident surface 140 and then are capable of being reflected by the side surface 144 to emit out of the secondary optic device 14 through the light emitting surface 142 into the void space 122 to be reflected by the reflecting surface 120. The diffusion plate 18 is disposed above the reflection part 12 and substantially seals the window 102. The void space 122 is located between the diffusion plate 18 and the reflection part 12. After reflected by the reflecting surface 120, the light beams pass through the void space 122 and the diffusion plate 18 and are diffused by the diffusion plate 18 out of the planar light apparatus 1 so as to be formed as a planar light source.

In the embodiment, the side surface 144 is an elliptic surface; in other words, the cross-section of the secondary optic device 14 perpendicular to the reflecting surface 120 has a partial elliptic profile. A focus 1440 (whose location is indicated by a cross mark in FIG. 2) of the elliptic surface is located in the void space 122. The projection of the focus 1440 on the reflecting surface 120 is located at the center of the reflecting surface 120, i.e. substantially at the geometric center of the circular secondary optic device 14. In other words, the focus 1440 is located substantially at a half of a length of the reflecting surface 120 in the direction of an optical axis 162a of the light-emitting unit 162. Thereby, compared with the case of the prior art that a parabolic surface is used to direct light beams to travels in parallel, after emitted out of the secondary optic device 14, the light beams in the embodiment can travel toward the center of the reflecting surface 120, so that most of the light beams emitted by the light-emitting units 162 can be reflected by the reflecting surface 120 to be diffused by the diffusion plate 18 out of the planar light apparatus 1. Furthermore, the light-emitting units 162 are located substantially at the other focus 1442 (whose location is indicated by a cross mark in FIG. 2) of the elliptic surface. Based on the geometric properties of ellipse, after modulated by the secondary optic device 14, the light beams emitted by the light-emitting units 162 travel toward the focus 1440 in principle, so that the whole device lighting efficiency can be improved further. Therein, in FIG. 2, solid lines with an arrow presents the paths of the light beams, which is also applied in the following sectional views and will not be described in addition. In practice, an area of the reflecting surface 120 for reflecting most of the light beams can be adjusted by setting the distance between the focus 1440 and the reflecting surface 120. In addition, the secondary optic device 14 using elliptic surface can avoid the problem that the conventional secondary optic device uses a parabolic surface leads to the constraints of the structural thickness on the device lighting efficiency.

It is added that, as described above, the planar light apparatus of the invention does not use a physical light-guiding plate, so the problem that the conventional light-guiding plate absorbs light leading to intensity decay of light beams can be avoided. In the abovementioned embodiment, in principle, the void space 122 is filled with air. Air also absorbs light, but the absorption extent therefor is very much less than the conventional light-guiding plate. Moreover, there is no occurrence of total internal reflection, which probably occurs in a physical light-guiding plate, in the air in the void space 122. Therefore, the air in the void space 122 is quite different in essence to the physical light-guiding plate. In addition, in practice, the planar light apparatus 1 can be assembled under a vacuum, and thus the void space 122 encloses a vacuum.

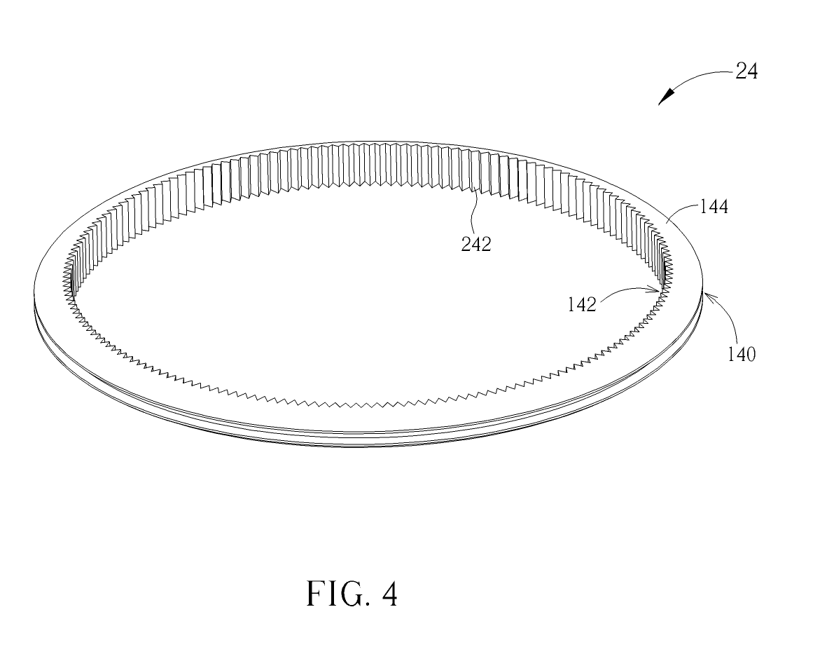

Please refer to FIG. 4. In another embodiment, the secondary optic device 24 uses a V-cut structure 242 to enhance the uniformity of device lighting. In the embodiment, the secondary optic device 24 is substantially similar in structure to the secondary optic device 14, and the secondary optic device 24 is therefore illustrated with the same notations as the secondary optic device 14. Furthermore, the configuration of the secondary optic device 24 is also the same as the secondary optic device 14. The explanation for the secondary optic device 14 is also applied herein and will not be repeated in addition. The main difference between the secondary optic device 24 and the secondary optic device 14 is that the V-cut structure 242 is formed on the light emitting surface 142 and extends perpendicular to the optical axis 162a and substantially perpendicular to the reflecting surface 120 (referring to FIG. 2)

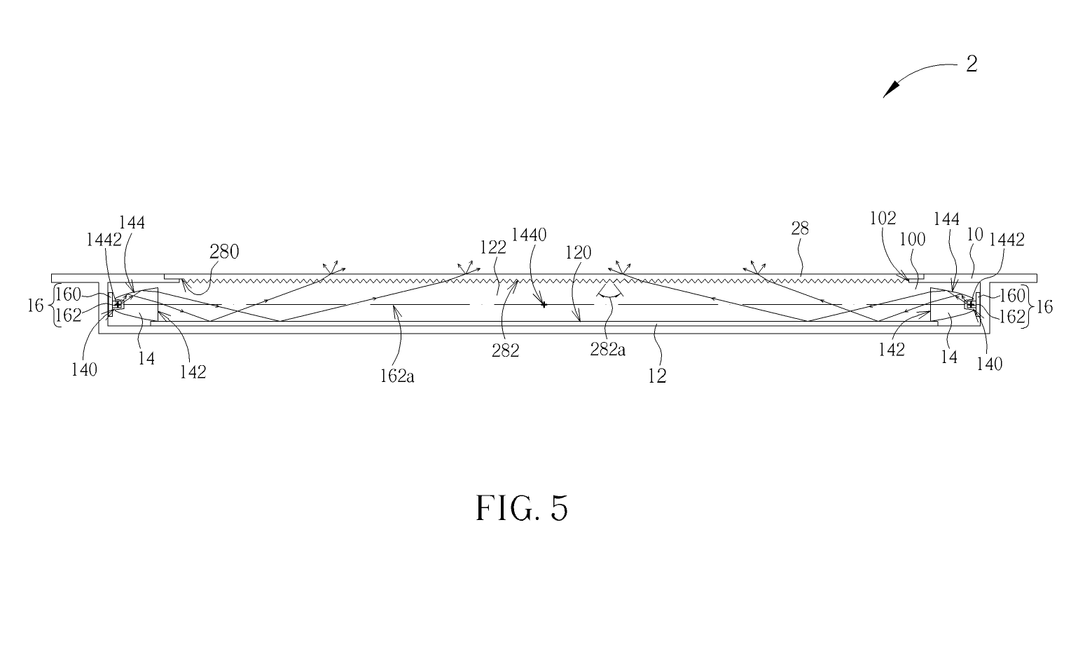

Please refer to FIG. 5. The planar light apparatus 2 is substantially similar in structure to the planar light apparatus 1, and the planar light apparatus 2 is therefore illustrated with the same notations as the planar light apparatus 1. The main difference between the planar light apparatus 2 and the planar light apparatus 1 is that the diffusion plate 28 of the planar light apparatus 2 has a V-cut structure 282 formed on a surface 280 of the diffusion plate 28 toward the reflecting surface 120. An included angle 282a of the V-cut structure 282 ranges from 80 to 120 degrees. Such V-cut structure 282 facilitates the enhancement the uniformity of device lighting. For other descriptions of the planar light apparatus 2, please refer to the relative descriptions of the planar light apparatus 1, which are not described herein.

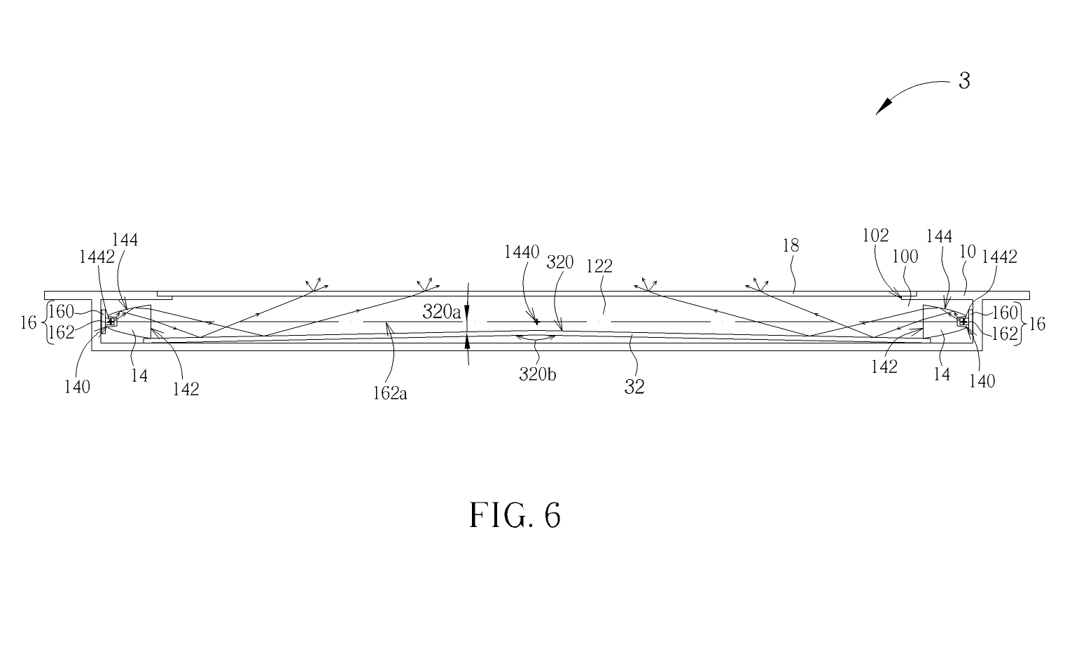

In the above embodiments, the optical axis 162a is substantially parallel to the reflecting surface 120, but the invention is not limited thereto. Please refer to FIG. 6. The planar light apparatus 3 is substantially similar in structure to the planar light apparatus 1, and the planar light apparatus 3 is therefore illustrated with the same notations as the planar light apparatus 1. The main difference between the planar light apparatus 3 and the planar light apparatus 1 is that the reflecting surface 320 of the reflection part 32 of the planar light apparatus 3 is disposed to slant toward the optical axis 162a. An included angle 320a between the reflecting surface 320 and the optical axis 162a ranges from 0 to 30 degrees. Because the planar light apparatus 3 is disc-shaped, the reflecting surface 320 shows a conical surface, of which the coning angle 320b ranges from 120 to 180 degrees. The slanted disposition of the reflecting surface 320 is conducive to the improvement of the uniformity of device lighting. For other descriptions of the planar light apparatus 3, please refer to the relative descriptions of the planar light apparatus 1, which are not described herein.

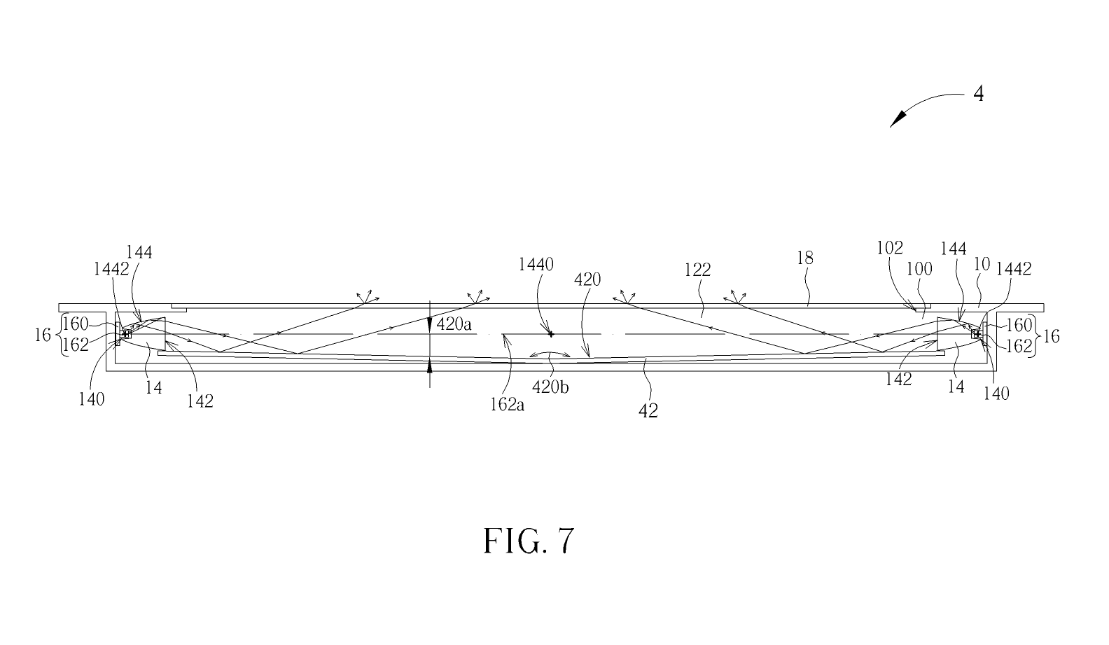

In the above embodiment, the reflecting surface 320 is disposed to protrude into the void space 122, but the invention is not limited thereto. Please refer to FIG. 7. The planar light apparatus 4 is substantially similar in structure to the planar light apparatus 1, and the planar light apparatus 4 is therefore illustrated with the same notations as the planar light apparatus 1. The main difference between the planar light apparatus 4 and the planar light apparatus 1 is that the reflecting surface 420 of the reflection part 42 of the planar light apparatus 4 is disposed to slant away from the optical axis 162a. An included angle 420a between the reflecting surface 420 and the optical axis 162a ranges from 0 to 30 degrees. Because the planar light apparatus 4 also is disc-shaped, the reflecting surface 420 shows a conical surface, of which the coning angle 420b ranges from 120 to 180 degrees. The reflecting surface 420 is disposed to protrude outward from the void space 122, which also is conducive to the improvement of the uniformity of device lighting. For other descriptions of the planar light apparatus 4, please refer to the relative descriptions of the planar light apparatus 1, which are not described herein.

It is added that, in the structural configurations of the planar light apparatuses 3 and 4, the reflecting surfaces 320 and 420 are disposed to protrude inward or outward so as to be nonparallel to the optical axis 162a, so that the uniformity of device lighting can be improved; however, the invention is not limited thereto. For example, the disposition angle of the light-emitting unit 162 can be modified such that the optical axis 162a slants toward the reflecting surface 120. The major axis of the elliptic surface of the secondary optic device 14 is correspondingly modified so as to point toward the reflecting surface 120. In such case, a nonparallel effect between the optical axis 162a and the reflecting surface 120 is also produced, which is conducive to the enhancement of the uniformity of device lighting as well. In addition, in the embodiments, the secondary optic device 14 is shaped in a circle, so as to improve the symmetry of the lighting field shape of the apparatus, but the invention is not limited thereto. For example, the secondary optic device and the light-emitting device are disposed in pairs and symmetrically in parallel, which also can perform the efficacy of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A planar light apparatus, comprising:
a reflection part having a reflecting surface;
a secondary optic device having a light incident surface, a light emitting surface, and a side surface between the light incident surface and the light emitting surface, a void space being formed between the secondary optic device and the reflection part, the reflecting surface facing the void space, the secondary optic device being disposed such that the light emitting surface faces the void space, the side surface being an elliptic surface, a focus of the elliptic surface being located in the void space, a projection of the focus on the reflecting surface being at a center of the reflecting surface; and
a light-emitting device disposed opposite to the light incident surface, wherein light beams emitted by the light-emitting device into the secondary optic device through the light incident surface are capable of being reflected by the side surface to emit out of the secondary optic device through the light emitting surface into the void space to be reflected by the reflecting surface.

2. The planar light apparatus of claim 1, wherein the light-emitting device comprises a light-emitting unit located substantially at another focus of the elliptic surface.

3. The planar light apparatus of claim 1, wherein the light-emitting device has an optical axis, the reflecting surface is disposed to slant away from the optical axis, and an included angle between the reflecting surface and the optical axis ranges from 0 to 30 degrees.

4. The planar light apparatus of claim 1, wherein the light-emitting device has an optical axis, the reflecting surface is disposed to slant toward the optical axis, and an included angle between the reflecting surface and the optical axis ranges from 0 to 30 degrees.

5. The planar light apparatus of claim 1, wherein the secondary optic device is a circular part, the light emitting surface surrounds the void space, and the light-emitting device comprises a plurality of light-emitting units disposed around the circular part.

6. The planar light apparatus of claim 5, wherein the focus of the elliptic surface is located at a center of the circular part.

7. The planar light apparatus of claim 1, wherein the light-emitting device has an optical axis, the secondary optic device has a V-cut structure formed on the light emitting surface, and the V-cut structure extends perpendicular to the optical axis and substantially perpendicular to the reflecting surface.

8. The planar light apparatus of claim 1, further comprising a diffusion plate disposed above the reflection part, the void space being located between the diffusion plate and the reflection part, wherein the light beams reflected by the reflecting surface pass through the void space and the diffusion plate and are diffused by the diffusion plate.

9. The planar light apparatus of claim 8, wherein the diffusion plate has a V-cut structure formed on a surface of the diffusion plate toward the reflecting surface.

10. The planar light apparatus of claim 9, wherein an included angle of the V-cut structure ranges from 80 to 120 degrees.

11. The planar light apparatus of claim 1, wherein the void space is filled with air.
